(19) United States
(12) Patent Application Publication
(10) Pub. No.: US 2017/0361488 A1
(43) Pub. Date: Dec. 21, 2017

(54) Compact Planer

(71) Applicant: Robert Bosch GmbH, Stuttgart (DE)

(72) Inventor: Peter Jack Wierzchon, Morton Grove, IL (US)

(21) Appl. No.: 15/534,677

(22) PCT Filed: Dec. 11, 2015
(86) PCT No.: PCT/US2015/065240

§ 371 Date: Jun. 9, 2017

Related U.S. Application Data
(60) Provisional application No. 62/090,491, filed on Dec. 11, 2014.

(51) Int. Cl. B27C 1/10; B27C 1/14

(52) U.S. Cl. CPC B27C 1/10; B27C 1/14

(57) ABSTRACT

A power tool includes a housing, and a cutting assembly supported by the housing. The power tool further includes a motor assembly operatively coupled to the cutting assembly and arranged on a first side of the housing. The power tool further includes an actuator operatively coupled to the motor assembly and configured to actuate the motor assembly. The actuator is arranged on a second side of the housing that is opposite the first side of the housing.

### CLAIM OF PRIORITY

This application claims priority to U.S. Provisional Patent Application No. 62/090,491 which is entitled “Compact Planer,” and was filed on Dec. 11, 2014, the entire contents of which are hereby incorporated by reference herein.

### BACKGROUND

Finish carpentry involves a significant amount of time fitting millwork to the irregularities and uneven surfaces of drywalled ceilings and walls or floor surfaces. Base molding, door and window casings, and crown moldings typically require scribing and some material removal to yield a quality fit. The material removal (which can include sawing, sanding, grinding, or planing) is performed on straight cut millwork, to modify the linear edge to conform to the existing surface profile. The traditional method of fitting woodwork involves use of a low angle block plane, which offers excellent control, but requires the user to apply repetitive manual force to perform the cutting action. Another drawback to use of a block plane is that the tool requires time consuming blade sharpening and honing to maintain acceptable cutting performance. Blade sharpening is a significant detractor from productivity, since the block plane must be disassembled for sharpening. If the blade is not razor sharp, wood tearout and poor surface appearance will result. Block plane blades are typically dedicated to a single tool and replacements are costly.

Power planers, on the other hand, can be bulky and heavy, making them difficult to operate. Additionally, many power planers require both hands of the user, making them feel different to use than a traditional block plane. Moreover, power planers often have complex design, making them difficult to produce and expensive to repair. Accordingly, it is desirable to provide a power planer which has a compact and simple configuration and is similar to use as a traditional block plane.

### SUMMARY

The power planer disclosed herein includes a housing which has a motor portion, configured to receive a motor assembly, arranged orthogonally to a main body portion, configured to receive a cutting assembly, a power source, and an actuator. Because the motor assembly is arranged to the side of the main body, the main body portion of the housing is able to be more compactly configured. In particular, the size of the main body portion of the housing is limited by the size of power source and of the cutting assembly. Additionally, the side configuration of the motor assembly allows the motor to directly drive the cutting assembly because the drive shaft axis of the motor is aligned with the axis of the cutter head of the cutting assembly when performing a cutting operation.

### BRIEF DESCRIPTION OF THE DRAWINGS

FIG. 1 shows a perspective view of a power planer including a housing, a cutting assembly, and other functional components.

FIG. 2 shows a perspective view of the power planer of FIG. 1 with the housing removed.

FIG. 3 shows a perspective view of the housing of the power planer of FIG. 1.

FIG. 4 shows a left side perspective view of the power planer of FIG. 1.

FIG. 5 shows a right side cross-sectional view of the power planer of FIG. 1.

FIG. 6 shows left side perspective view of a functional component of the power planer of FIG. 1.

FIG. 7 shows a top cross-sectional view of the power planer of FIG. 1.

FIG. 8 shows a front perspective view of a portion of the cutting assembly of the power planer of FIG. 1.

FIG. 9 shows a schematic front cross-sectional view of the cutting assembly of the power planer of FIG. 1.

FIG. 10A shows a left side perspective view of a component of the cutting assembly of the power planer of FIG. 1.

FIG. 10B shows a schematic front cross-sectional view of the component of the cutting assembly of FIG. 10A.

FIG. 11A shows a right side perspective view of another component of the cutting assembly of the power planer of FIG. 1.

FIG. 11B shows a schematic front cross-sectional view of the component of the cutting assembly of FIG. 11A.

FIG. 12A shows a right side perspective view of another component of the cutting assembly of the power planer of FIG. 1.

FIG. 12B shows a schematic front cross-sectional view of the component of the cutting assembly of FIG. 12A.

FIG. 13 shows a schematic cross-sectional view of another component of the cutting assembly of the power planer of FIG. 1.

FIG. 14 shows a front cross-sectional view of the power planer of FIG. 1.

FIG. 15 shows a front perspective view of another power planer including a housing, a cutting assembly, and other functional components.

### DETAILED DESCRIPTION

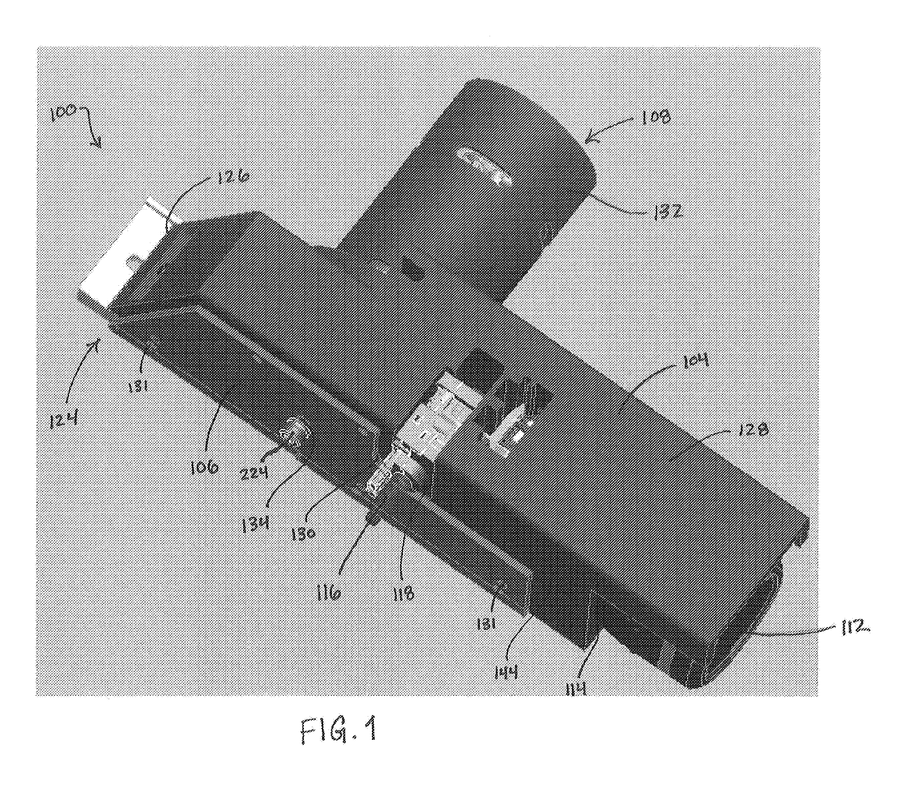

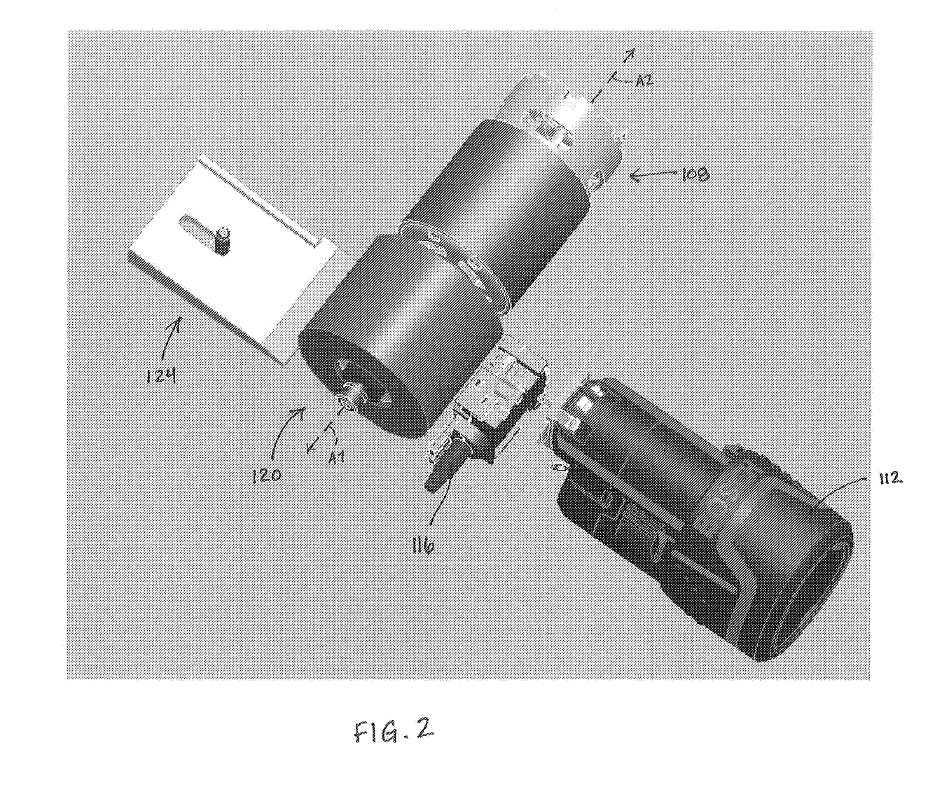

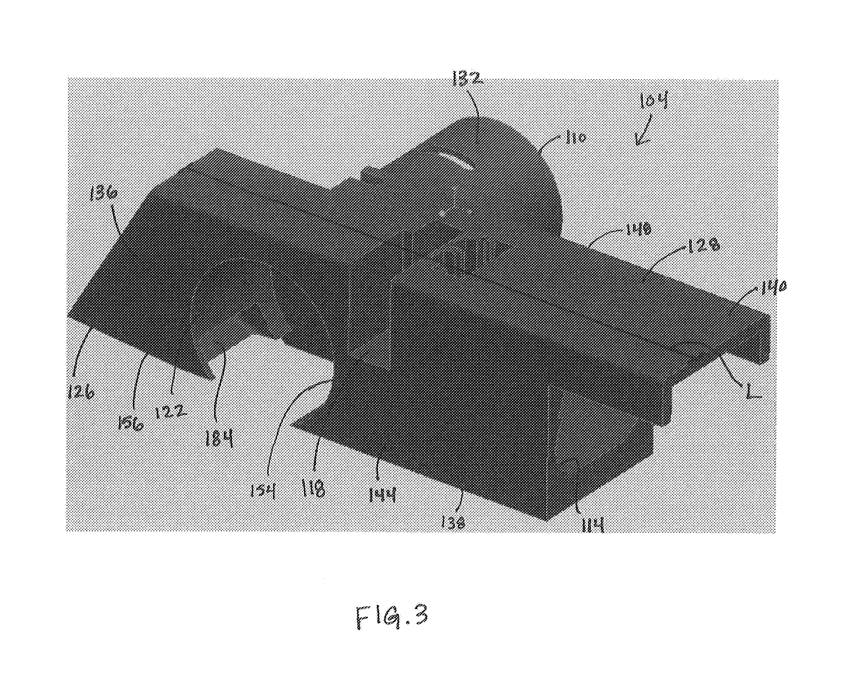

The planer 100, as shown in FIG. 1, includes a housing 104, a support plate 106, a motor assembly 108, and a power source 112 for operating the motor assembly 108. As shown in FIG. 2, which has the housing 104 removed, the planer 100 also includes an actuator 116 for actuating the power source 112, a cutting assembly 120 operated by the motor assembly 108, and a depth adjustment assembly 124 for adjusting a depth of cut made by the cutting assembly 120. As shown in FIG. 3, the housing 104 is made of a durable material such as, for example, a hard plastic material, and includes a main body portion 128 and a motor portion 132. The motor portion 132 extends substantially orthogonally relative to the main body portion 128 and includes a motor assembly receiver 110 configured to receive the motor assembly 108 (shown in FIG. 2). The main body portion includes a power source receiver 114 configured to receive the power source 112 (shown in FIG. 2), an actuator receiver 118 configured to receive the actuator 116 (shown in FIG. 2), a cutting assembly receiver 122 (shown in FIG. 2) configured to receive the cutting assembly 120 (shown in FIG. 2), and a depth adjustment assembly receiver 126 configured to receive the depth adjustment assembly 124.

The main body portion 128 has a front 136, a rear 140, a left side 144, and a right side 148. The main body portion 128 has a length L, extending from the front 136 to the rear 140, which is, for example, between 150 mm and 200 mm. In the embodiment shown, the motor portion 132 of the housing 104 is arranged on the right side 148 of the main body portion 128, and the support plate 106 and the actuator receiver 118, containing the actuator 116 (shown in FIG. 2), are positioned on the left side 144 of the main body portion 128. Thus, when the planer 100 is gripped in the user's right hand such that the front 136 is aimed away from the user's body and the rear 140 is aimed toward the user's body, the left side 144 of the main body portion 128 is arranged nearest to the user's body and the right side 148 of the main body portion 128 is arranged farthest from the user's body. Accordingly, the embodiment shown is arranged to be more easily operated by a right-handed user because the user is able to easily manipulate the actuator 116 with the right thumb and because the motor portion 132 of the housing 104 does not obstruct the user's view of the work area. However, in an alternative embodiment, the planer 100 can have the opposite arrangement so as to be preferable for a left-handed user wherein the actuator 116 is positioned on the right side 148 of the main body portion 128 to be easily operated by the user's left thumb and the motor portion 132 is positioned on the left side 144 of the main body portion 128 so it does not obstruct the user's view.

Returning to FIG. 1, the support plate 106 is configured to be coupled to the left side 144 of the housing 104 to provide support to the housing 104 and to provide support to the cutting assembly 120 where the cutting assembly 120 is supported by the housing 104. The support plate 106 is a flat metal plate made of, for example, steel, including an actuator accommodation groove 130 configured to accommodate the actuator 116, which projects from the left side 144 of the housing 104. In the embodiment shown, the support plate 106 is fastened to the left side 144 of the housing 104 by fastening members (not shown) inserted through fastening openings 131 in the support plate 106 and into the left side 144 of the housing 104. The fastening members can be, for example, screws, rivets, or other suitable, stable, durable members. However, in alternative embodiments, the support plate 106 can be fastened to the housing 104 in another manner which is durable and stable. The support plate 106 also includes a support shaft fastener opening 134 extending through the support plate 106 and configured to receive a support shaft fastener 224 to couple the cutting assembly 120 (shown in FIG. 2) to the housing 104 via the support plate 106, as described in more detail below.

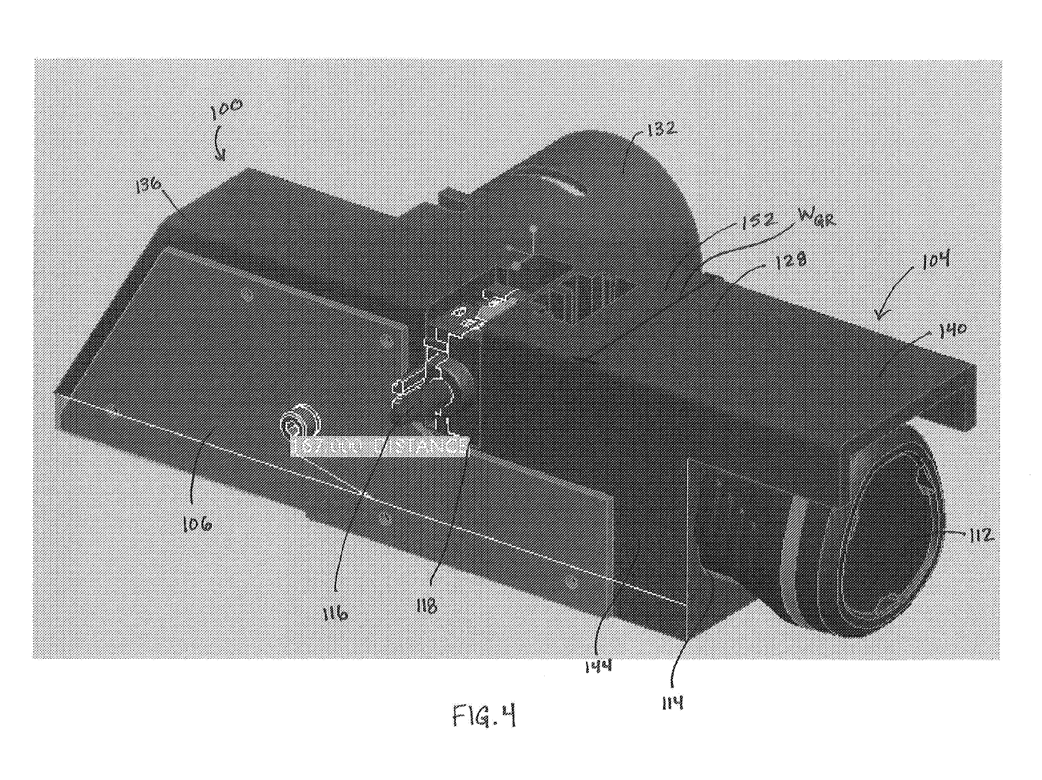

As shown in FIG. 4, the main body portion 128 of the housing 104 includes a grip region 152 positioned around where a user's palm contacts the planer 100 when the user grips the main body portion 108. The grip region 152 has a width W_{GR} which is sized to be gripped comfortably by the user's hand. For example, the grip region 152 can have a width W_{GR} of approximately 50 mm. The actuator receiver 118 is positioned within the grip region 152 such that the user can easily manipulate the actuator 116 with the thumb while gripping the planer 100. In the embodiment shown, the actuator 116 has a push-button configuration to be depressed by the user to alternately turn on and off the planer 100. In an alternative embodiment, however, the actuator 116 can have a different configuration to be manipulated by the user to alternately turn on and off the planer 100.

In an alternative embodiment, the grip region 152 can include a safety mechanism (not shown) which would require contact by both the user's thumb and another finger on the grip region 152 in order to operate the planer 100. For example, the safety mechanism could include a contact mechanism positioned on the right side 148 of the housing 104 configured to be contacted by the user's middle or ring finger. In this embodiment, both the actuator 116 and the contact mechanism would have to be contacted in order to turn on the planer 100. This safety mechanism would decrease the risk of injury to the user by placing the fingers of the hand operating the planer 100 in an unsafe position.

The cutting assembly receiver 122 (shown in FIG. 3) is positioned between the grip region 152 and the front 136 of the housing 104 and is aligned with the motor portion 132 of the housing 104 such that the motor assembly 108 (shown in FIG. 2) is positioned adjacent to the cutting assembly 120 (shown in FIG. 2) when the planer 100 is assembled as shown in FIG. 4. As shown in FIG. 3, the cutting assembly receiver 122 extends to the left side 144 of the housing 104 such that an opening 154 of the cutting assembly receiver 122 is at least partially formed in the left side 144 of the housing 104 and at least partially formed in a bottom surface 138 of the housing 104. Accordingly, as shown in FIG. 4, the support plate 106 is positioned to cover the portion of the opening 154 of the cutting assembly receiver 122 that is formed in the left side 144 of the housing 104 so that the cutting assembly 120 (shown in FIG. 2) is not exposed on the left side 144 of the housing 104 when the planer 100 is assembled.

With continued reference to FIG. 4, the power source receiver 114 is positioned near the rear 140 of the housing 104 and removably receives the power source 112. In the embodiment shown, the power source 112 is a 12 volt battery which can be removed from the housing 104 for charging and replaced within the housing 104 for operating the planer 100. To this end, the power source receiver 114 includes a fastening element (not shown) configured to engage with a complementary fastening element (not shown) on the power source 112. The fastening element and complementary fastening element are configured to be manipulated by the user to engage and release the battery 112 as desired. In an alternative embodiment, the power source 112 can be an electrical cord or another feature configured to provide power to the planer 100. In another alternative embodiment, the power source 112 can be non-removably received in the power source receiver 114.

Turning now to FIG. 5, a right perspective cross-sectional view of the power planer 100 is shown with the cutting assembly 120 received within the cutting assembly receiver 122. As shown, the housing 104 includes a bottom surface 138, and the cutting assembly receiver 122 includes an opening 142, which is a portion of the opening 514, formed in the bottom surface 138 of the housing 104. The cutting assembly 120 is arranged within the cutting assembly receiver 122 such that the cutting assembly 120 contacts a surface to be cut via the opening 142.

Also shown in FIG. 5, the depth adjustment assembly receiver 126, which adjustably receives the depth adjustment assembly 124, is positioned at the front 136 of the housing 104. The depth adjustment assembly receiver 126 includes a lowermost surface 156, an adjustment screw opening 158 positioned above the lowermost surface 156, and an adjustment screw window 160, which is in communication with the lowermost surface 156 via the adjustment screw opening 158 and is open to the front 136 of the housing 104. The lowermost surface 156 of the depth adjustment assembly receiver 126 is separated from the rest of the bottom surface 138 of the housing 104 by the opening 142. The depth adjustment assembly 124 includes a wedge shaped plate 162 having a bottom surface 164 and a top surface 168 which angle toward each other to form the tapered wedge shape having a thicker portion 170 and a thinner portion 174. The wedge shaped plate 162 of the depth adjustment assembly 124 is coupled to the depth adjustment assembly receiver 126 such that the thicker portion 170 is arranged nearer to the front 136 of the housing 104 and the thinner portion 174 is arranged nearer to the rear 140 of the housing 104. Furthermore, the wedge shaped plate 162 of the depth adjustment assembly 124 is coupled to the depth adjustment assembly receiver 126 such that the bottom surface 138 of the housing 104 and the bottom surface 164 of the wedge shaped plate 162 rest on the surface to be cut with the planer 100. In other words, the front 136 of the housing 104 is propped up by the wedge shaped plate 162 to a further extent than the rear 140 of the housing 104.

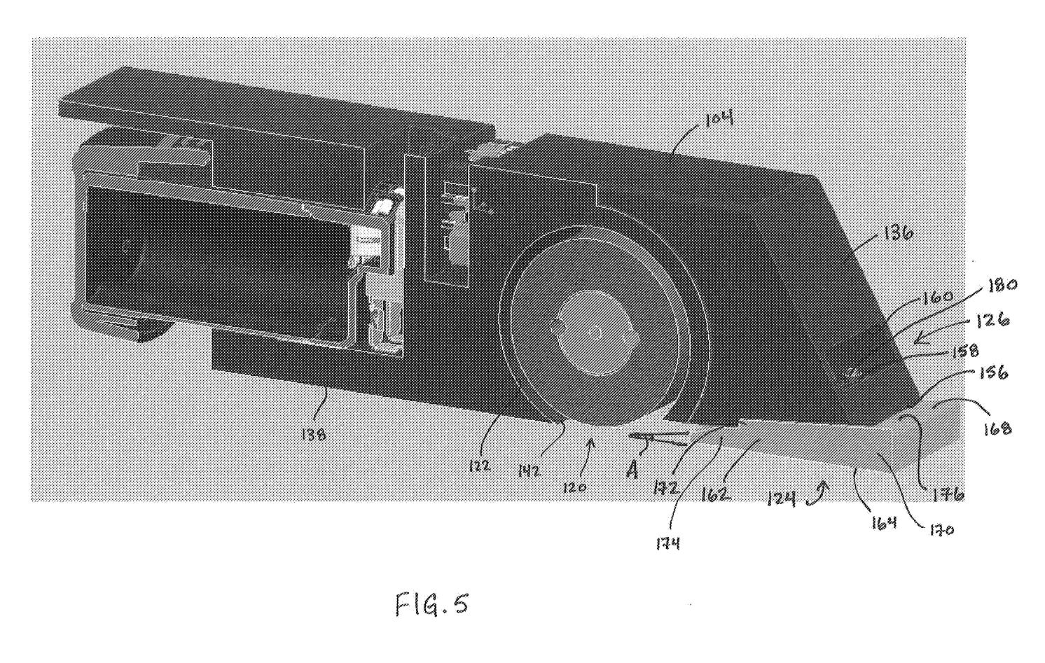

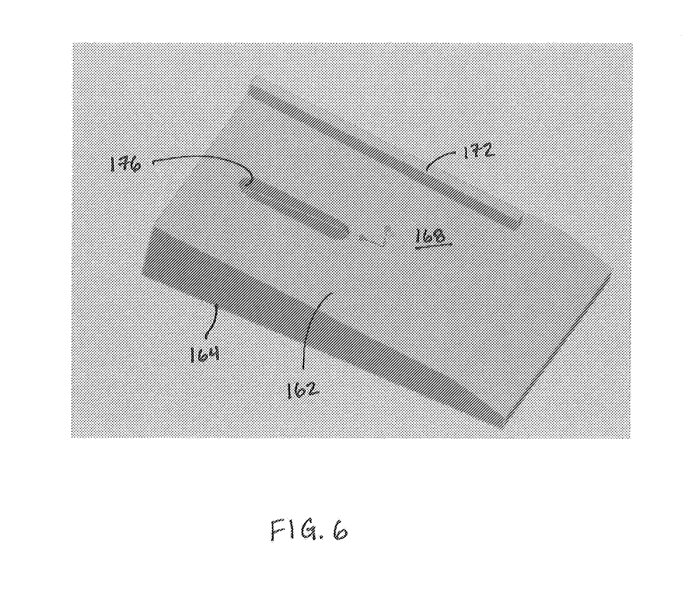

As shown in more detail in FIG. 6, the wedge shaped plate 162 of the depth adjustment assembly 124 includes an alignment ledge 172, which projects upwardly from the top surface 168, and an elongated opening 176, which extends through the top surface 168 and the bottom surface 164 and is configured to receive an adjustment screw 180 (shown in FIG. 5) extending through the wedge shaped plate 162.

When the depth adjustment assembly 124 is received within the depth adjustment assembly receiver 126, as shown in FIG. 5, the top surface 168 of the depth adjustment assembly 124 rests against the lowermost surface 156 of the depth adjustment assembly receiver 126. Additionally, a portion of the adjustment screw 180 which extends above the top surface 168 of the wedge shaped plate 162 is received through the adjustment screw opening 158 and into the adjustment screw window 160 to couple the wedge shaped plate 162 to the housing 104. Accessed by the user through the adjustment screw window 160, the adjustment screw 180 is manipulated by the user to tighten or loosen the adjustment screw 180 and therefore tighten or loosen the wedge shaped plate 162 relative to the housing 104.

To adjust the depth of a cut made by the planer 100, the user loosens the connection between the wedge shaped plate 162 and the housing 104 by loosening the adjustment screw 180 via the adjustment screw window 160. When the wedge shaped plate 162 is loosened, the wedge shaped plate 162 is free to translate relative to the housing 104 by sliding the elongated opening 176 along the adjustment screw 180, which passes through the elongated opening 176 of the depth adjustment assembly 124 and through the adjustment screw opening 158 of the depth adjustment assembly receiver 126. When sliding the wedge shaped plate 162, the alignment of the wedge shaped plate 162 relative to the housing 104 is maintained by contact of the alignment ledge 172 along the right side 148 of the housing 104. Due to the tapered wedge shape of the wedge shaped plate 162, sliding the wedge shaped plate 162 toward the rear 140 of the housing 104 increases an angle A the of the housing 104 from the front 136 to the rear 140 of the housing 104. The increased angle A results in a shallower cut made by the planer 100. Conversely, sliding the wedge shaped plate 162 away from the rear 140 of the housing 104 decreases the angle A, resulting in a deeper cut made by the planer 100. When the angle A has been adjusted to produce cuts of the desired depth by the planer 100, the user tightens the adjustment screw 180 to fix the position of wedge shaped plate 162 relative to the housing 104 for use of the planer 100.

As shown in FIG. 3, the front 136 of the housing 104 also includes a chip passage 184 arranged above the lowermost surface 156. The chip passage 184 is an elongated opening which extends within the housing 104 from the cutting assembly receiver 122 to the adjustment screw window 160 (shown in FIG. 5). The chip passage 184 is configured to pass chips and other debris generated by the planer 100 during a cutting operation to a location outside of the housing 104. To this end, the chip passage 184 is in open communication with both the cutting assembly receiver 122 and the adjustment screw window 160. Accordingly, chips and debris generated by the cutting assembly 120 during use of the planer 100 are moved outside the housing 104 by exiting the cutting assembly receiver, passing through the chip passage 184 and the adjustment screw window 160 and out of the front 136 of the housing 104.

As shown in FIG. 7, the motor assembly 108, received within the motor portion 132 of the housing 104, includes a motor 188 and a drive shaft 192. The motor 188 is electrically connected to the power source 112 via the actuator 116 (shown in FIG. 2) and other electrical connections (not shown) within the main body portion 128 of the housing 104. Accordingly, when the actuator 116 is switched to an “on” position, the power source 112 supplies electrical power to the motor 188 to activate the motor 188 to rotate the drive shaft 192. Conversely, when the actuator 116 is switched to an “off” position, the power source 112 ceases supplying electrical power to the motor 188 and no longer activates the motor 188 to rotate the drive shaft 192. In an exemplary embodiment, the motor 188 can be a 12 volt or an 18 volt motor.

With continued reference to FIG. 7, the cutting assembly 120 includes a coupling 200, configured to couple the cutting assembly 120 to the drive shaft 192 of the motor assembly 108, and a cutter head 204, coupled to the coupling 200. The cutting assembly 120 also includes a first bearing 208, a second bearing 212, a support shaft 216, a washer 220, and support shaft fasteners 224, all arranged within the cutter head 204. Because, as shown, the drive shaft 192 is arranged to be coaxial with the cutter head 204, the drive shaft 192 can directly drive the cutter head 204. In other words, when the cutting assembly 120 is received within the cutting assembly receiver 122, an axis of rotation A1 of the cutting assembly 120 (shown in FIG. 2) is coaxial with an axis of rotation A2 of the motor assembly 108 (shown in FIG. 2). This simple relationship between the motor assembly 108 and the cutting assembly 120 allows the planer 100 to be compact and easy to maintain and repair. Additionally, the direct drive configuration eliminates energy losses associated with a conventional belt drive or gear drive configuration.

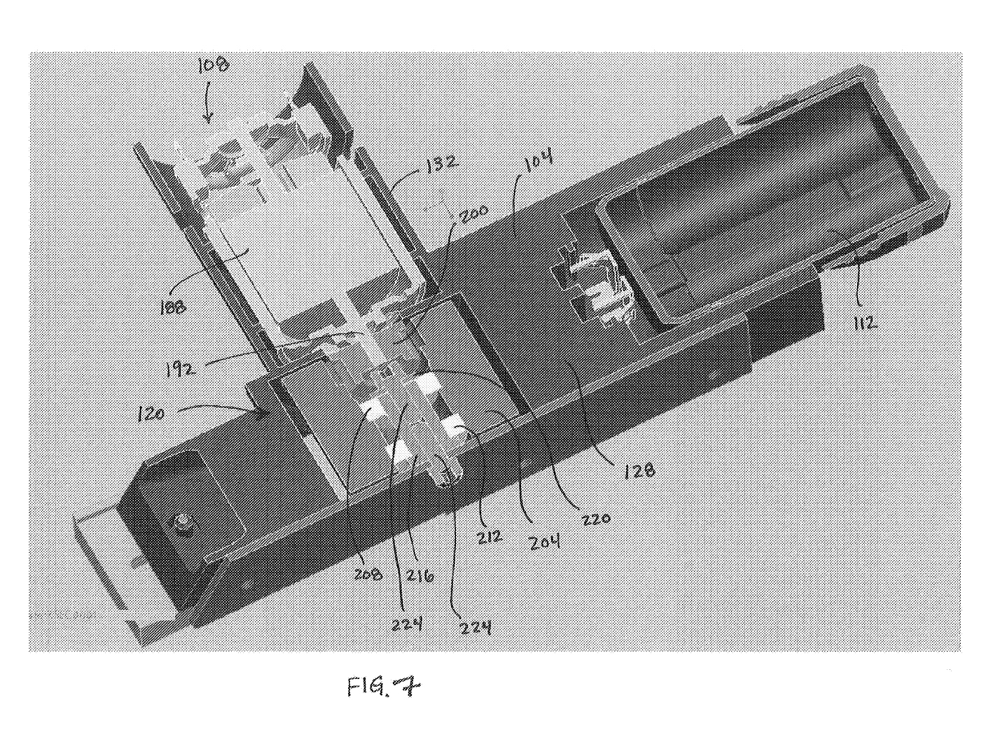

As shown more clearly in FIG. 8, the cutting assembly 120 also includes a blade 228 coupled to a circumferential surface 232 of the cutter head 204 with blade fasteners 236. During a cutting operation, the motor 188 is operated to rotate the drive shaft 192, which rotates the coupling 200 to rotate the cutter head 204. When the cutter head 204 rotates, the blade 228 spins and repeatedly contacts a work surface to make a cut. The cutter head 204 can be made of, for example, aluminum. In the embodiment shown, the blade 228 is a single rectangular blade, which can be detached from the cutter head 204 to be replaced. Additionally, the same blade 228 can be rotated and replaced to face the opposite direction so that another cutting edge is facing in the cutting direction. The blade 228 can be, for example, a 30×12×1.5 mm carbide blade. In an alternative embodiment, the blade 228 can be more than one blade coupled to the cutter head 204. For example, the blade 228 can be two square blades coupled side-by-side to the cutter head 204. The square blades can be, for example, 14×14×2 mm carbide blades. In this embodiment, the square blades could be rotated to expose four different cutting edges in the cutting direction, requiring fewer replacement blades to be purchased over the lifetime of the planer 100.

Turning now to FIG. 9, a cross-sectional view of the cutting assembly 120 and the support plate 106 is shown to illustrate the relationship between the elements of the cutting assembly 120 in more detail. The cutter head 204 is substantially cylindrical and includes the circumferential surface 232, having a blade receiver 234 configured to receive the blade 228 with blade fasteners 236 (shown in FIG. 8), and a central bore 240. The cutter head 204 has a coupling end 244, configured to receive the coupling 200, and a support plate end 248, arranged facing toward the support plate 106. The central bore 240 has a diameter which varies from the coupling end 244 to the support plate end 248 to accommodate the varying diameters of the coupling 200, first bearing 208, second bearing 212, support shaft 216, washer 220, and support shaft fasteners 224. Additionally, the central bore 240 includes coupling bearing receivers 250 formed in the coupling end 244 of the cutter head 204 configured to cooperate with coupling bearing receivers 280 formed in the coupling 200 to receive coupling bearings 284. The coupling bearings 284 enable the rotational movement of the coupling 200 to be smoothly translated into rotational movement of the cutter head 204 by accommodating linear and angular misalignment while transmitting motor torque to the cutter head 204. The coupling bearings 284 can be, for example, 4 mm ball bearings. In an alternative embodiment, the bearing coupling type could be used to intentionally allow the motor axis to be inclined relative to the cutter head axis, allowing for increased motor clearance away from the work surface.

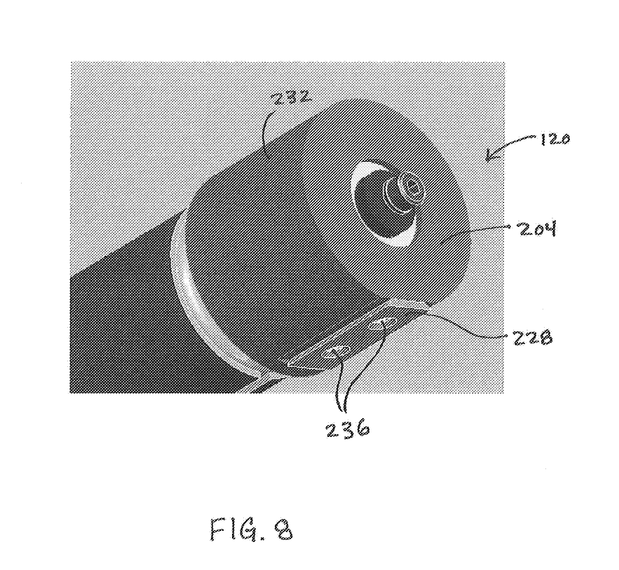

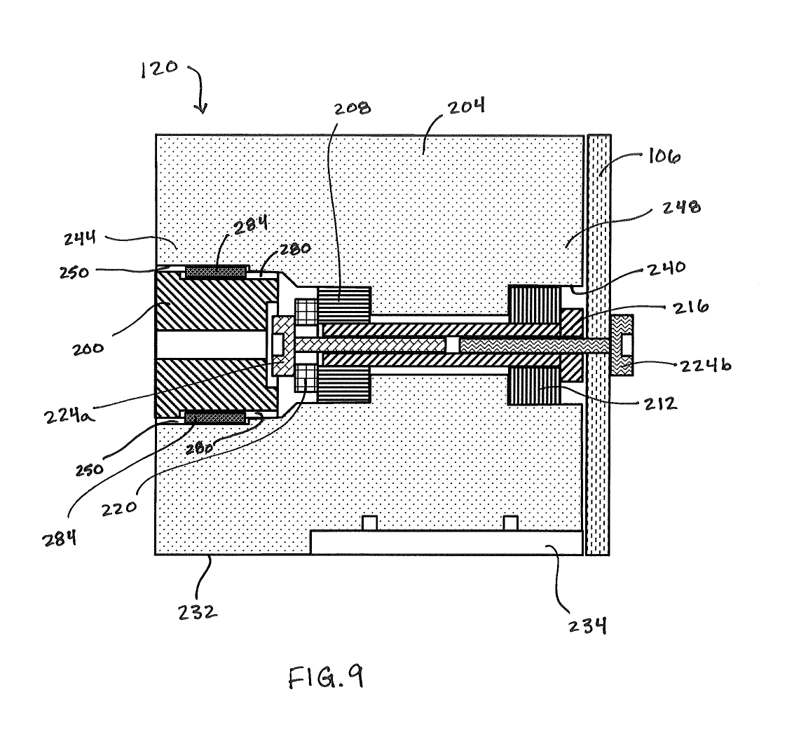

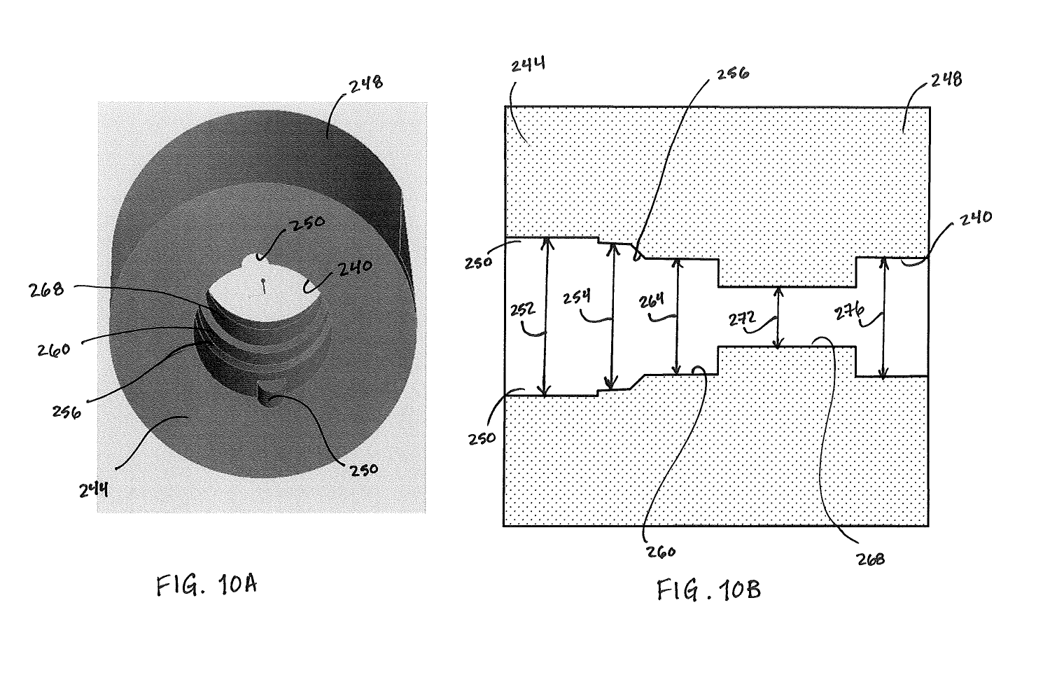

As shown in FIGS. 10A and 10B, adjacent to the coupling end 244, where the central bore 240 includes the coupling bearing receivers 250, the central bore 240 has a coupling bearing diameter 252 sized to accommodate the coupling 200 and the coupling bearings 284 (shown in FIG. 9). Adjacent to the coupling bearing diameter 252, the central bore 240 has a coupling diameter 254, sized to receive the coupling 200 (shown in FIG. 9). Adjacent to the coupling diameter 254, the central bore 240 includes an angled portion 256 having a tapering diameter that is smaller than the coupling diameter 254 to prevent the coupling 200 from moving within the central bore 240 from the coupling end 244. Adjacent the angled portion, the central bore 240 includes a first bearing portion 260, having a first bearing diameter 264 sized to receive the first bearing 208 with some allowance such that rotational movement of the cutter head 204 does not drive the first bearing 208 rotationally on the support shaft 216. Adjacent to the first bearing portion 260 of the central bore 240 is a retaining portion 268, having a retaining diameter 272 which is smaller than the first bearing diameter 264 to prevent the first bearing 208 from translating along the central bore 240 toward the support plate end 248 during rotational movement of the cutter head 204. Finally, adjacent the support plate end 248, the central bore 240 has a second bearing diameter 276 sized to receive the second bearing 212 in the same manner that the first bearing diameter 264 receives the first bearing 208. The retaining portion 268 prevents the second bearing 212 from translating along the central bore 240 toward the coupling end 244 during rotational movement of the cutter head 204.

Turning now to FIGS. 11A and 11B, the coupling 200 includes a circumferential surface 288, the coupling bearing receivers 280 formed in the circumferential surface 288, and a central bore 292 passing through the coupling 200 and configured to fit tightly on the drive shaft 192 of the motor assembly 108 (shown in FIG. 2) such that rotational movement of the drive shaft 192 translates to rotational movement of the coupling 200. The coupling 200 can be made of, for example, steel. The coupling 200 also includes a support shaft fastener accommodation 296, which has a larger diameter than the central bore 292, and is sized to provide a gap between the coupling 200 and the support shaft fastener 224a (shown in FIG. 9) to prevent interference with the support shaft fasteners 224a during rotation of the coupling 200.

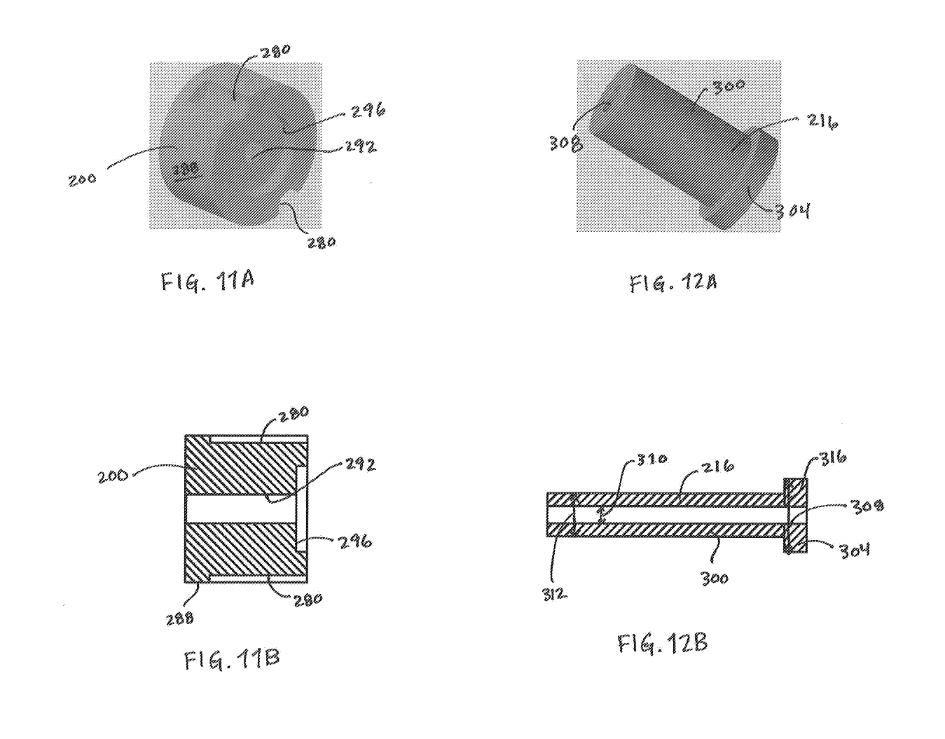

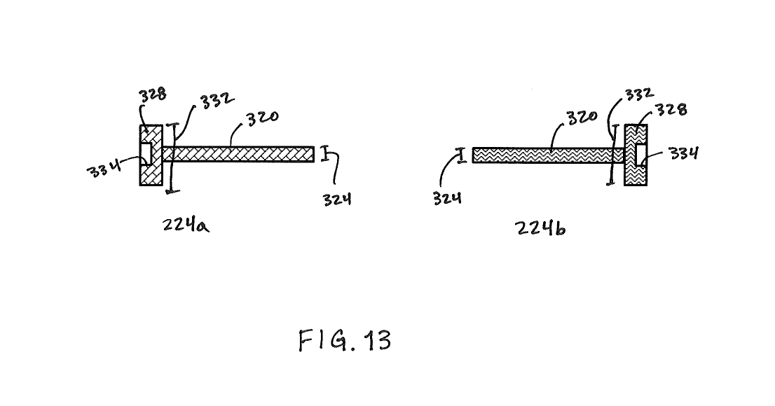

As shown in FIGS. 12A and 12B, the support shaft 216 includes a shaft 300, a head 304, and a central bore 308 passing through both the shaft 300 and the head 304. When assembled as shown in FIG. 9, the support shaft 216 is positioned within the central bore 240 of the cutter head 204 such that the shaft 300 is arranged toward the coupling end 244 and the head 304 is arranged toward the support plate end 248. The support shaft 216 can be made of, for example, steel. The shaft 300 has a shaft diameter 312 which is smaller than a head diameter 316 and is smaller than the retaining diameter 272 of the central bore 240 of the cutter head 204. The central bore 308 of the support shaft 216 has a central bore diameter 310 which is sized to receive portions of the support shaft fasteners 224a, 224b therein to retain the support shaft 216 in position within the central bore 240 of the cutter head 204.

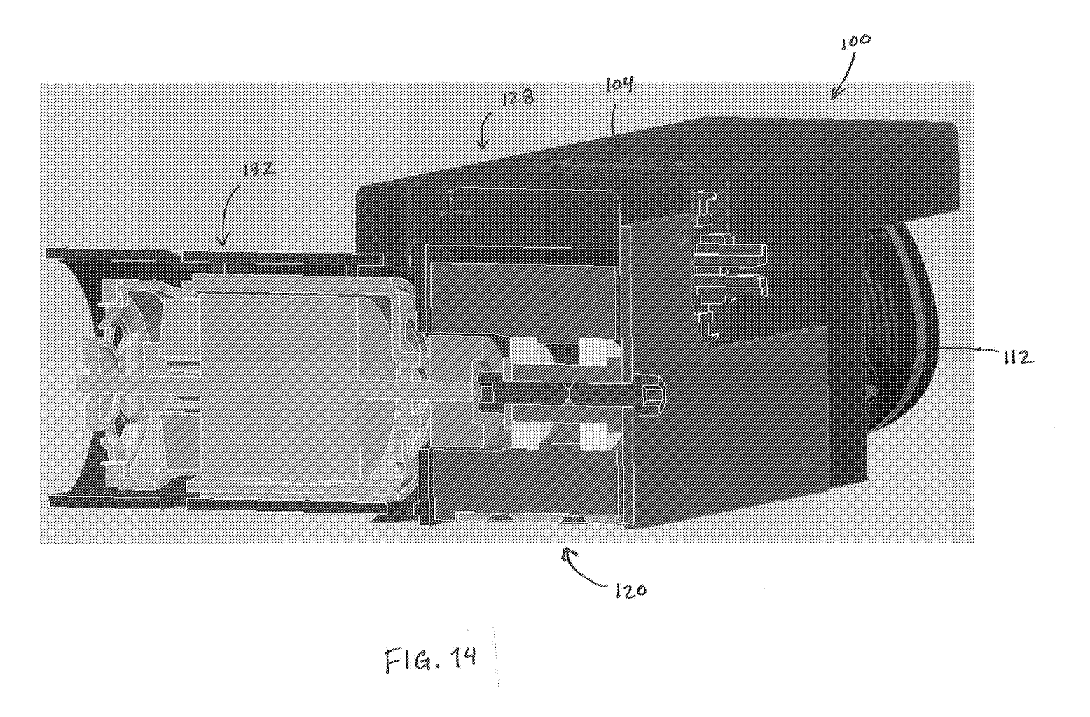

Turning now to FIG. 13, the two support shaft fasteners 224a, 224b of the cutting assembly 120 (shown in FIG. 9) are shown. The support shaft fasteners 224a, 224b are identical to one another and, when arranged in the cutting assembly 120 as shown in FIG. 9, are arranged facing in opposite directions and extending within the central bore 240 of the cutter head 204. Each support shaft fastener 224a, 224b includes a shaft 320 having a shaft diameter 324 and a head 328 having a head diameter 332. When arranged within the cutting assembly 120, the first support shaft fastener 224a is positioned entirely within the central bore 240 of the cutter head 204 such that the head 328 is arranged toward the coupling 200 and the shaft 320 is positioned within the support shaft 216. The second support shaft fastener 224b is arranged opposite the first support shaft fastener 224a and positioned such that the shaft 320 extends out of the central bore 240 of the cutter head 204 and through the support shaft fastener opening 134 in the support plate 106. The head 328 of the second support shaft fastener 224b is positioned outside the cutter head 204 on the opposite side of the support plate 106. Accordingly, via the support plate 106, the second support shaft fastener 224b retains the cutting assembly 120 in position relative to the housing 104.

To this end, the shaft diameters 324 are smaller than the central bore diameter 310 of the support shaft 216 so that the shafts 320 of the support shaft fasteners 224a, 224b can fit within the central bore 308 of the support shaft 216. The shaft diameters 324 are also smaller than the support shaft fastener opening 134 in the support plate 106 so that the second support shaft fastener 224b can be received through the support plate 106. Furthermore, the head diameters 332 are larger than the support shaft fastener opening 134 in the support plate 106 so that the second support shaft fastener 224b can be retained on the support plate 106. As shown in FIG. 13, each of the support shaft fastener heads 328 includes an engagement recess 334 configured to be engaged to arrange and tighten the support shaft fasteners 224a, 224b during manufacturing and production of the cutting assembly 120.

Returning now to FIG. 9, when the cutting assembly 120 is assembled, the coupling 200 is positioned at the coupling end 244 of the cutter head 204 and within the central bore 240 such that the coupling bearing receivers 280 in the coupling 200 are aligned with the coupling bearing receivers 250 in the cutter head 204 and coupling bearings 284 are received within the coupling bearing receivers 280, 250. Additionally, the head 328 of the first support shaft fastener 224a is positioned within the support shaft fastener accommodation 296 and the shaft 320 of the first support shaft fastener 224a extends into the central bore 308 of the shaft 300 of the support shaft 216, toward the support plate end 248 of the cutter head 204. The washer 220 is positioned between the head 328 of the first support shaft fastener 224a and the first bearing 208 on the first support shaft fastener 224a such that the shaft 320 of the first support shaft fastener 224a passes through the opening of the washer 220. The first bearing 208 is positioned within the first bearing portion 260 of the central bore 240 and the second bearing 212 is positioned within the support plate end 248 of the central bore 240 such that the cutter head 204 bears upon the first and second bearings 208, 212 during rotational movement. The shaft 300 of the support shaft 216 extends through the first bearing 208 and the second bearing 212 and extends from the first bearing portion 260 of the central bore 240, through the retaining portion 268, and to the support plate end 248 of the cutter head 204. The head 304 of the support shaft 216 is positioned between the second bearing 212 and the support plate 106 and prevents the second bearing 212 from translating toward the support plate 106 during rotational movement of the cutter head 204. The head 328 of the second support shaft fastener 224b is positioned on a side of the support plate 106 opposite the support shaft 216. The shaft of the second support shaft fastener 224a extends through the support shaft fastener opening 134, through the head 304 of the support shaft 216, and into the central bore 308 of the shaft 300 of the support shaft 216.

In operation of the planer 100, the user first sets the angle A of the planer 100 to achieve cuts of the desired depth. The user reaches into the adjustment screw window 160 in the front 136 of the housing 104 and loosens the adjustment screw 180. The user then slides the wedge shaped plate 162 of the depth adjustment assembly 124 toward or away from the rear 140 of the housing 104, by sliding the elongated opening 176 along the adjustment screw 180, to increase or decrease the angle A of the planer, respectively. Once the wedge shaped plate 162 has been positioned to enable cuts of the desired depth, the user reaches into the adjustment screw window 160 again to tighten the adjustment screw 180 and fix the wedge shaped plate 162 into position relative to the housing 104.

Once the angle A of the planer is set, the user grips the main body portion 128 of the housing 104 and switches the actuator 116 to the “on” position. The actuator 116 then provides electrical power from the power source 112 to the motor assembly 108 to operate the motor 188. When operated, the motor 188 rotationally drives the drive shaft 192. Because the drive shaft 192 is tightly received within the coupling 200 of the cutting assembly 120, the rotational movement of the drive shaft 192 is translated to the cutting assembly 120. The coupling 200 translates rotational movement of the drive shaft 192 to the cutter head 204 via coupling bearings 284 received in coupling bearing receivers 280 in the coupling 200 and coupling bearing receivers 250 formed in the coupling end 244 of the cutter head 204. The cutter head 204 rotates relative to the housing 104 such that the blade 228 performs a cutting operation.

During a cutting operation, the cutter head 204 also rotates relative to the support shaft 216 and the support shaft fasteners 224a, 224b. The first and second bearings 208, 212 rotate on the support shaft 216 so that the rotational movement of the cutter head 204 is not translated to the support shaft fasteners 224a, 224b. Because the second support shaft fastener 224b is coupled to the support plate 106, and because the first and second support shaft fasteners 224a, 224b are retained within the support shaft 216, the support shaft fasteners 224a, 224b maintain the position of the cutting assembly 120 relative to the housing 104 during rotational movement of the cutter head 204. Any chips and debris generated by the blade 228 during the cutting operation are ejected through the chip passage 184 and out of the front 136 of the planer 100. When a cutting operation has been completed, the user switches the actuator 116 to the “off” position to cease operation of the planer 100.

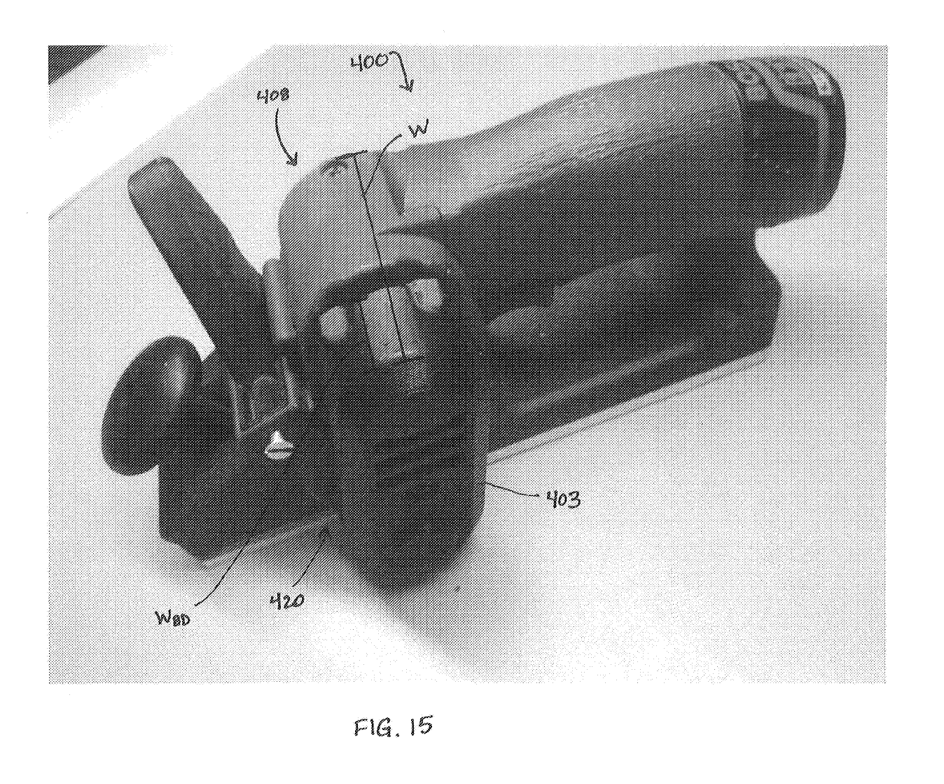

As shown in FIG. 14, by positioning the motor portion 132 on the right side of the main body portion 128 of the housing 104, the planer 100 is made more compact for use. The arrangement enables the grip region width W_{GR} (shown in FIG. 4) to be limited by the size of the cutting assembly 120 and the power source 112 received within the housing 104. Thus, the arrangement allows the grip region 152 (shown in FIG. 4) to be comfortably sized for gripping during use.

FIG. 15 shows an alternative embodiment of a power planer 400, which is substantially similar in configuration and function to power planer 100, described above. Accordingly, similar reference numerals are used to describe similar parts. However, power planer 400 includes the motor assembly 408 positioned directly above the cutting assembly 420. This configuration is a more conventional layout of a power planer, but is still a compact arrangement of the device. One benefit of the configuration of power planer 400 is that the center of gravity of the planer 400 is nearly directly over the cutting assembly 420. Additionally, the configuration of the power planer 400 is easily gripped by a user's left hand or right hand, making the tool usable by right-handed and left-handed users. Additionally, the arrangement of the motor assembly 408 above the cutting assembly 420 also directs the user's hands away from the cutting assembly 420, which increases user safety. An overall width W of the power planer 400 is narrow and includes a belt drive 403 having a narrow width W_{BD} which further enables a narrow overall width W of the power planer 400. The configuration of the power planer 400 enables use of a brushless motor while delivering all of the benefits of a compact and well balanced tool.

While the invention has been illustrated and described in detail in the drawings and foregoing description, the same should be considered as illustrative and not restrictive in character. It is understood that only the preferred embodiments have been presented and that all changes, modifications, and further applications that come within the spirit of the invention are desired to be protected.

1. A power tool, comprising:
a housing;
a cutting assembly supported by the housing;
a motor assembly operatively coupled to the cutting assembly and arranged on a first side of the housing; and
an actuator operatively coupled to the motor assembly and configured to actuate the motor assembly, the actuator arranged on a second side of the housing that is opposite the first side of the housing.

2. The power tool of claim 1, wherein:
an axis of rotation of the cutting assembly is coaxial with an axis of rotation of the motor assembly.

3. The power tool of claim 1, wherein:
the housing includes an opening configured such that the cutting assembly contacts a surface to be cut via the opening.

4. The power tool of claim 3, further comprising:
a depth adjustment assembly configured to adjust a depth of a cut made by the cutting assembly, the depth adjustment assembly movably coupled to the housing nearer to a front of the housing than the opening is.

5. The power tool of claim 4, wherein:
the depth adjustment assembly includes a bottom surface configured to rest on the surface to be cut;
the housing includes a bottom surface configured to rest on the surface to be cut; and
at least a portion of the opening is formed in the bottom surface of the housing.

6. The power tool of claim 4, wherein:
the depth adjustment assembly includes a wedge having a thicker portion and a thinner portion; and
the thicker portion is arranged nearer to the front of the housing than the thinner portion is.

7. The power tool of claim 4, wherein:
the housing further includes a depth adjustment assembly receiver configured to movably receive the depth adjustment assembly,
the depth adjustment assembly receiver includes a lowermost surface configured to rest on a top surface of the depth adjustment assembly.

8. The power tool of claim 7, wherein:
the depth adjustment assembly receiver further includes a fastener opening configured to receive a fastener therethrough to couple the depth adjustment assembly to the depth adjustment assembly receiver.

9. The power tool of claim 8, wherein:
the depth adjustment assembly further includes an elongated opening configured to receive the fastener therethrough to slidably couple the depth adjustment assembly to the depth adjustment assembly receiver.

10. The power tool of claim 8, wherein:
the depth adjustment assembly receiver further includes a window formed on the front of the housing and configured to provide access to the fastener opening and to enable manipulation of the fastener within the fastener opening.

11. The power tool of claim 10, wherein:
the housing further includes a cutting assembly receiver configured to receive the cutting assembly, and
the housing further includes a passage in direct communication with the window and with the cutting assembly receiver and configured to pass debris from the cutting assembly receiver to the window.

12. The power tool of claim 7, wherein:
the depth adjustment assembly includes a ledge extending upwardly from the top surface of the depth adjustment assembly and configured to contact the housing to slidably guide the lowermost surface of the depth adjustment assembly receiver along the top surface of the depth adjustment assembly.

13. The power tool of claim 12, wherein:
the ledge is configured to contact the second side of the housing.

13. (canceled)

14-20. (canceled)

21. The power tool of claim 3, wherein:
at least a portion of the opening is formed in the second side of the housing;
the power tool further includes a support plate fixedly coupled to the second side of the housing and configured to cover the portion of the opening formed in the second side of the housing.

22. The power tool of claim 21, wherein:
the housing includes a cutting assembly receiver configured to receive the cutting assembly; and
the cutting assembly is coupled to the support plate such that the support plate at least partially supports the cutting assembly within the cutting assembly receiver.

23. The power tool of claim 22, wherein:
the cutting assembly includes a coupling and a support shaft fastener;
the motor assembly includes a drive shaft operatively coupled to the coupling to rotate the cutting assembly; and
the support shaft fastener is fixedly coupled to the support plate.

24. The power tool of claim 23, wherein:
the coupling and the support shaft fastener are coaxial;
the cutting assembly further includes a cutting head rotatably received within the cutting assembly receiver; and
the coupling and the support shaft fastener are arranged at least partially within the cutting head.

25. The power tool of claim 24, wherein:
the coupling and the support shaft fastener are coaxial with the cutting head.

26. The power tool of claim 23, wherein:
the coupling and the support shaft fastener are coaxial with the drive shaft.

27. The power tool of claim 23, wherein:
the support shaft fastener is at least partially arranged on a side of the support plate that is opposite the second side of the housing.
